(19) United States
(12) Patent Application Publication
(10) Pub. No.: US 2014/0170230 A1
(43) Pub. Date: Jun. 19, 2014

(54) COMPOSITE OF NATURAL FOODS FOR ENHANCING NORMALIZATION OF TEAR SECRETION

(71) Applicant: Che-Hou CHANG, Tainan City (TW)

(72) Inventor: Che-Hou CHANG, Tainan City (TW)

(21) Appl. No.: 14/034,788

(22) Filed: Sep. 24, 2013

(30) Foreign Application Priority Data
Dec. 19, 2012 (TW) 101148540

(51) Int. Cl. A23L 1/30; A23L 1/325

(52) U.S. Cl. CPC A23L 1/3004; A23L 1/325
USPC 424/520

(57) ABSTRACT

The invention is in relation to a composite, which enhances normalization of tear secretion, and is made of selections from natural foods as eels, soybeans, oats, corn, champignons and sesames. Moreover, through above-mentioned natural foods, there are contents of vitamins, including vitamin B₁, vitamin B₆, vitamin B₁₂, niacin and biotin as well as minerals of phosphorus, calcium and manganese etc., they are able to improve the neurogenic inflammation reactions. Meanwhile, through above-mentioned soybeans, sesames, oats and champignons, they further contain the steroid compounds such as the sterols, steroidal saponins, β-sitosterols and ergosterols, they contain plant steroid hormones, which can effectively relieve the inflammatory reactions as well as regression of lacrimal gland, while increasing its metabolic function as well as to improve tear secretion, as a result, to ensure the constant equilibrium between quantity and quality of tear film, in other words, the characteristics of nourishing, anti-inflammation and maintaining homeostasis.

### BACKGROUND OF THE INVENTION

1. Field of the Invention

The invention is in relation to a composite of natural foods for enhancing the normalization of tear secretion. More particularly, a composite which can effectively relieve the inflammatory reactions as well as regression of lacrimal gland, while increasing its metabolic function as well as to improve tear secretion, as a result, to ensure the constant equilibrium between quantity and quality of tear film, in other words, the characteristics of nourishing anti-inflammation and maintaining homeostasis.

2. Description of Related Art

Dry eye is one of the diseases commonly seen quite often in the ophthalmic clinic and it is related to uneven distributive or insufficient quantity of tear secretion or excessive evaporation of tear in the eye, as a result, the ocular surface unable to be kept moist properly by the tear, in other words, it is dry lesion on the epithelium of ocular surface, for which is caused by abnormality of tear film.

The common symptoms of dry eye include eye redness, dryness of the eyes, sense of foreign body, eyestrain, the feeling of heavy eyelids, uncomfortable eyes, stabbing pain, blurred vision, undulation of vision, itchy eyes, photophobia, anemophobia etc. In recent years, owing to the environmental factors (e.g., work environment with air conditioning for a quite long time or poor ventilation), wearing contact lenses or computer working have specific evident influence on the occurrence of dry eye. Therefore, it is the most importance for an ophthalmologist should be more careful of taking case history to avoid missing diagnosis.

According to the clinical experience, dry eye is induced by five causes including aqueous tears deficiency, deficiency of mucin, abnormality of lipid, abnormality of eyelids and pathological changes of cornea epithelium.

In generally, It has been estimated that dry eye patients occur almost exclusively (>60%) in visiting ophthalmic clinic, therein middle and old aged people are the majority. There are various causes of dry eye e.g., aging, sex hormonal imbalance of postmenopausal women, chronic keratitis, poor eyelid closure, wearing contact lenses, autoimmune diseases, rheumatism and some side effects induced by medical drugs and so on. So far, there is no good radical cure for dry eye.

At the present time, commercially available products of artificial tears and eye ointments have effects in lubrication and moisture only, for relieving mild eye discomfort, but no substantial curing efficacy in moderate or severe dry eye since they cannot stay on the eye long enough.

The course of dry eye treatment of the inventor is as follows:
1. The inventor suffered from severe dry eye in 2006, visited to the Zhou ophthalmic clinic on November 6, 13 and 20 in the same year, the prescription are (1) Sulomin eye drops, (2) Yen san 0.02% 5 ML and (3) Decasone 5 ML Soln, Marpina Eye Drops, respectively. Although three weeks of treatment, the patient condition cannot be alleviated and even more serious.
2. There is no efficacy after the three weeks of treatment by the Zhou ophthalmic clinic, so that the inventor was transferred to the e-eye laser institute and accepted treatment on Nov. 23 and 24 in 2006. There are two kinds of prescription used, one kind of prescription includes (1) Morcasin and (2) 0.1 FML (Viscone), and the other kind of prescription includes (1) hydroxypropyl methylcellulose (artificial tears, A.T.) and (2) Sultisomezule Tetra hydrozoline. However, the patient condition cannot be alleviated, and even more serious.
3. There is no efficacy after the two days of treatment by the e-eye laser institute, therefore, the inventor was transferred again to the kuo general hospital on Nov. 27, 2006, Dec. 4, 2006 and Jan. 8, 2007, the doctor newly diagnosed his case as dry eye which was a chronic disease and difficult to cure radically. The prescription include Spersallerg Eye Drops 10 ML and Tears Naturale 15 ML/BOT. However, the patient condition cannot be alleviated, and even more serious after one weeks of treatment.

Therefore, the inventor explores the causes and understands the side effects of the foregoing prescription according to the contents listed on the medicine bag. The symptoms induced by the side effects of the foregoing prescription include intraocular pressure changes, mydriasis, burning of the eyes, stabbing pain, lacrimation, blurred vision, eye redness, uncomfortable eyes and so on. After one week (Dec. 4, 2006), when the inventor was back for reexamination and told the doctor about his conditions, but the doctor was not able to make further treatment for the inventor with new prescriptions.

In view of the foregoing disadvantages of using artificial tears temporarily for the treatment of deficiency of tear secretion, as a result, the inventor began to collect the information about various natural foods at home and abroad to study and improve the treatment methods. Therefore, the object of the present invention is to provide a food therapy made of natural foods and the present invention can improve the patient condition and cause the patient condition to fully recover from dry eye.

### SUMMARY OF THE INVENTION

The improvement of the mutual regulation between neuronal and hormonal regulation is the object of the present invention to Ensure the constant equilibrium between guantity and guality of tear film and Enhance the normalization of tear secretion.

### The Pathogenic Mechanisms of Dry Eye.

Homeostasis of the tear film involves delicate neuronal and hormonal regulatory mechanisms [symbol] Reference 1 and 2 [symbol] . If the Neurogenic inflammatory reactions and androgenic deficiency cause the changes of tear quality or decrease quantity of tear secretion, which is the major pathogenic mechanisms of leading to dry eye. In order to response to the Extrinsic or intrinsic factors, stimulation of ocular surface (e.g., cornea, conjunctiva and eyelids) and lacrimal apparatus (e.g., lacrimal gland, accessory lacrimal gland, conjunctival goblet cells and meibomian gland) may cause inflammatory reactions of lacrimal gland through neural reflex loop, which cause decrease tear secretion and enhance to secrete its cytokines on ocular surface, so that ocular surface was stimulated to aggravate the inflammatory reactions, therefore cause inflammatory reactions of lacrimal gland furthermore through neural signal transmits to lacrimal gland again, as a result, to form a vicious circle. The androgen deficiency with the ability of anti-inflammation, as a result, to enhance aggravating inflammatory reactions, therefore, it affects the normal secretory function of lacrimal gland and meibomian gland and accelerates the occurrence of dry eye meanwhile. As mentioned above, the relation between neuronal and hormonal regulatory mechanisms is interdependent.

To reach the object, the present invention is to provide a composite which is made of selections from natural foods as eels, soybeans, oats, corn, champignons and sesames. Using the foregoing natural foods containing vitamin B₁, vitamin B₆, vitamin B₁₂, niacin and biotin as well as minerals of phosphorus, calcium and manganese etc., they are able to improve the neurogenic inflammatory reactions. Meanwhile, through above-mentioned soybeans, sesames, oats and champignons, they contain the steroid compounds such as the sterols, steroidal saponins, β-sitosterols and ergosterols, they contain plant steroid hormones, which can effectively relieve the inflammatory reactions as well as regression of lacrimal gland, while increasing its metabolic function as well as to improve tear secretion, as a result, to ensure the constant equilibrium between quantity and quality of tear film, in other words, the characteristics of nourishing, anti-inflammation and maintaining homeostasis.

As mentioned above, the natural foods composite for enhancing normalization of tear secretion can be used in the treatment of dry eye.
Reference 1: Zhu Zhi-Zhong (Editor-in-chief), Practical ocular surface Diseases (2004), Publishing house of Bei jing science technique, China. P35, P38, P130, P133-134.
Reference 2: Baudouin c. The pathology of dry eye. Surv ophthalmol 2001; 45:S211-220.

### DETAILED DESCRIPTION OF THE PREFERRED EMBODIMENT

The present invention can be performed by the following examples To further show the advantages, so that patent examiners can have more in-depth and detailed understanding of the present invention.

First, the composite for enhancing normalization of tear secretion is made of selections from natural foods including eels, soybeans, oats, corn, champignons and sesames. Using the foregoing natural foods containing

vitamin B₁, vitamin B₆, vitamin B₁₂, niacin and biotin as well as minerals of phosphorus, calcium and manganese etc., they are able to improve the neurogenic inflammatory reactions. Meanwhile, through above-mentioned soybeans, sesames, oats and champignons, they contain the steroid compounds such as the sterols, steroidal saponins, β-sitosterols and ergosterols, they contain plant steroid hormones, which can effectively relieve the inflammatory reactions as well as regression of lacrimal gland, while increasing its metabolic function as well as to improve tear secretion, as a result, to ensure the constant equilibrium between quantity and quality of tear film, in other words, the characteristics of nourishing, anti-inflammation and maintaining homeostasis.

Neuronal and hormonal regulatory mechanisms related to tear secretion [symbol] Reference 1 [symbol] are as follows:

1. Neuronal Regulation

Tear secretion involves innervation and neuronal regulation. The 7^{th} cranial nerve (facial nerve), 5^{th} cranial nerve (trigeminal nerve), sympathetic nerve and parasympathetic nerve, they participate in the innervation of tear secretion. Abundant sensory nerve endings distributed in cornea and various stimulations of sensitive feeling, generate nerve impulses and conduct to center. After that, the secretion and metabolism of tears are regulated by neural reflex loop.

Actually, parasympathetic nerve, sympathetic nerve and sensory nerve, they participate in tear secretion of lacrimal gland, wherein the parasympathetic nerve may release acetylcholine to stimulate the lacrimal gland for secretion of water, protein and electrolytes, sympathetic nerve may secrete noradrenaline, and the sensory nerve may secrete calcitonin gene-related polypeptide and substance P. Therefore, neuronal regulation plays an important role in tear secretion.

2. Hormonal Regulation

Previous studies show that androgen can regulate the physiological and immune activities of lacrimal gland and meibomian gland. Moreover, there are various steroid hormonal receptors in the tissues of lacrimal gland, meibomian gland, conjunctiva and cornea, they become hormonal target organs, these steroid hormones participate in regulation of lacriml gland function and metabolism as well as maintaining homeostasis. Therefore, the lacrimal hyposecretion of the old aged people is possibly related with hormone dysregulation. As mentioned above, the eye appears to be a target organ for sex hormones, therein these hormones play nourishing, anti-inflammation and maintaining homeostasis roles.

Dry eye occurs more often in females, especially for postmenopausal women. Previous studies consider that tear secretory deficiency is induced by estrogen deficiency. However, the syndrome of menopausal women accepted estrogen supplementary therapy, which cannot improve their tear secretory function, on the contrary, there is a higher incidence of dry eye. Moreover, using eye drops containing estrogen to treat dry eye patients, the results show that the patient condition cannot be improved in both of Tear Break up Time (TBUT) test and Schirmer's test (ST). Reference 3 indicates that estrogen induces lacrimal gland regression, lowers its metabolic function and decreases tear secretion.

According to researches related to androgen and dry eye [symbol] Reference 4 [symbol] , the results show that ovariectomization of rabbits cause their lacrimail gland regression, it is because of self-acting apoptosis of lacrimal gland acinus and interstitial cells, so as to cause lacrimal gland atrophy and secretory function loss. Therefore, using androgen can effectively relieve the inflammatory reactions as well as regression of lacrimal gland, while increasing its metabolic function as well as to improve tear secretion.

Reference 3: Sullivan D A, wickham L A, Rocha E M, et al. Influence of gender, sex steroid hormones and the hypothalamic-pituitary axis on the structure and function of lacrimal gland Adv Exp Med Biol 1998; 438:11-42.
Reference 4: Azzarolo A M, Mircheff A K, Kaswan R L, et al. Androgen support of lacrimal gland function Endocrine 1997; 6:39-45.

Therefore, the inventor uses natural foods to study the neurogenic inflammatory reaction, therein natural foods are considerable therapeutic efficacy. The food composite for enhancing the normalization of tear secretion, according to the present invention contains natural foods, i.e. eels, soybeans, oats, corn, champignons and sesames. The foregoing natural foods contain:
1. Vitamin B₁—sesames, soybeans, oats, corn, eels
2. Vitamin B₆—soybeans, champignons, oats
3. Vitamin B₁₂—oats, corn
4. Niacin—champignons, sesames, oats, eels
5. Biotin—corn, sesames, oats
6. Phosphorus—sesames, soybeans, champignons, corn, eels
7. Calcium—sesames, soybeans, champignons, eels, oats
8. Manganese—sesames, champignons, oats, soybeans, eels

The analytical results show that vitamins and minerals can maintain the normal function of the nervous system. Especially vitamin B₁ is the main component to constitute the nerves, it can make nerves act smoothly, in other words, it maintain normal nervous function, vitamin B₁ is called antineuritic factor.

The composite made of natural foods in the present invention can effectively relieve the inflammatory reactions of lacrimal gland as well as lacrimal gland regression, while increasing its metabolic function and normalize tear secretion. Further, the natural foods in the present invention contain:
1. Sterol—soybeans
2. Steroidal saponin—sesames
3. β—sitosterol oats
4. Ergosterol—champignons

Foregoing steroid compounds contain plant steroid hormones. Moreover, there are various steroid hormones receptors in the tissues of lacrimal gland, meibomian gland, conjunctiva and cornea. Therefore, the eye appears to be a target organ for sex hormones, therein these hormones play nourishing, anti-inflammation and maintaining homeostasis roles.

As mentioned above, keeping the constant equilibrium of tear film must depend on the mutual regulation between neuronal and hormonal regulation to ensure the normalization of tear secretion.

However, doing it yourself with the natural foods (such as cereal, fungus and sea food) used in the present invention could be achieved with healthy therapeutic efficacy, therein:

1. Sea Food (Eel)
Eel contains abundant fats, proteins and carbohydrates, has the reputation as ginsengs in the water, is a tonic in the comparison with other fishes. The nutrient components of eels include (1) proteins, (2) fats, (3) carbohydrates, (4) vitamins such as vitamin A, B₁, B₂, D, E and Niacin etc., (5) electrolytes including sodium, potassium, calcium and magnesium, (6) minerals including iron, copper, phosphorus, zinc, selenium and manganese, (7) Omega-3 fatty acid. Moreover, the significances of foregoing nutrient components in pharmacological aspects are as follows:
(1) Fats are important nutrient components for the synthesis of cholesterol and hormones. It can maintain the normal function of the lipid layer in the tear film. Therefore, lipid layer can delay the aqueous evaporation, avoid the tears flowing from the eyelid edge, and provide the lubrication between the ocular surface and the eyelid.
(2) Eels contain abundant proteins, proteins in tears include immunoglobulin, lysozyme and lactoferrin etc. protein content, there are specific antibacterial factors, so that they play defense of the ocular surface roles.
(3) The compound made of proteins and glycosyl-containing substance is called glycoprotein. The main component of mucin layer is glycoprotein. Moreover, vitamin A possess abilities to transport or activate glycosyl, so that vitamin A is essential in the glycoprotein synthesis. In addition, the mucin layer contacts the cornea and the conjunctiva directly, the mucin layer forms a wet hydrophillic surface, as a result, to increase uniform and stable distributive ability of water-glycoprotein colloid on the ocular surface. Moreover, the mucin layer can avoid the adsorption of foreign bodies, cells or pathogenic microorganisms on the ocular surface, meanwhile, when blinking it can keep the refractive of tear film in full as well as to reduce or prevent damage to the ocular surface.
(4) Electrolytes including sodium, potassium, calcium and magnesium, the foregoing electrolytes can balance the pH value of tears, adjust the flow of tears and the liquid between corneal epitheliums, and may control the permeability of the cell membrane. Therefore, the aquesous layer can supply the cornea with essential nutrients and oxygen, through the blinking action can remove epithelial debris, some of the metabolites and small foreign bodies, so that they can provide smooth optical surface with high quality.
(5) Vitamin E and selenium are antioxidants.
(6) Vitamin B₂ can eliminate eyestrain and eye allergies.
(7) Vitamin A is essential to maintain the distribution of goblet cells and mucin on ocular surface, people with serious deficiencies of vitamin A suffer from dry eye easily. Moreover, vitamin A is called axerophthol.
(8) The eel's livers contain abundant vitamin A can serve as an auxiliary therapeutic efficacy for dry eye.
(9) The eels contain vitamin B₁, niacin and minerals including phosphorus and manganese, they can maintain the normal functions of the nervous system.
(10) The eels are rich in fats, but they contain omega-3 unsaturated fatty acids. Therefore, the eels can be safe to eat for the patients with high blood pressure, high cholesterol.

According to the foregoing pharmacological analysis, the components of sea foods (eels) are relative to the maintaining of the constant equilibrium between quantity and quality of tear film.

2. Natural Foods (Cereal, Fungus and Seafood)
(1) Foods related to the maintaining of the normal functions of the nervous system: A. sesames, B. oats, C. corn, D.

soybeans, E. champignons, and F. eels.
(2) Foods related to hormonal regulation (plant steroid hormones): A. soybeans, B. sesames, C. oats, and D.

### Champignons.

Cooking method and suggested use of the natural foods used in the present invention are as follows:

Ingredients: an eel (the composite includes approximately 50-70% by weight of eels, wherein the composite comprising 50% by weight of eels is preferred). Cereal and fungus the composite includes approximately 5-10% by weight of sesames, approximately 5-10% by weight of oats, approximately 5-10% by weight of corn, approximately 5-10% by weight of soybeans and approximately 5-10% by weight of champignons, wherein 10% by weight of the foregoing ingredients are preferred, respectively.

Cooking Method: put an eel, sesames, oats, corn, soybeans and champignons into a pot and all the above ingredients are to be boiled in water.

Suggested use: divide the portion equally into three meals for intake each day.

Course of Treatment
1. The inventor suffered from dry eye induced by blurred vision, so that the inventor accepted the visual acuity test (wearing glasses) was (0.3) before eating the composite of natural foods.
2. Stage 1—after eating the composite of natural foods for one week, the symptoms including eye redness, dryness of the eyes, sense of foreign body, stabbing pain and itchy eyes were improved slightly and the visual acuity test was (0.5).
3. Stage 2—after Stage 1 and eating the composite of natural foods for one week continually, the symptoms in the step 1 and also symptoms of eyestrain, blurred vision, eye allergies (sensitive to light, wind and smoke) and the feeling of heavy eyelids were improved evidently and the visual acuity test was (0.8).
4. Stage 3—after Stage 2 and eating the composite of natural foods for one week continually, the foregoing symptoms are improved completely and the visual acuity test was (1.0).

The medical certificate of the inventor before and after eating the composite of natural foods are provided by the Kuo general hospital and the Zhou ophthalmic clinic, respectively.

According to the above description about the composite of natural foods and examples, the present invention has the advantages as following:
1. The composite of natural foods can maintain the normal functions of the nervous system.
2. The composite of natural foods can lubricate, moisturize, clean, nourish and anti-infection on the ocular surface.
3. The composite of natural foods can maintain the constant equilibrium between quantity and quality of tear film.
4. The composite of natural foods can eliminate eyestrain and eye allergies.
5. The composite of natural foods can slow down the aging process.
6. The composite of natural foods have anti-bacterial, anti-inflammatory and immunomodulatory functions.
7. The composite of natural foods can be safe to eat for the patients with high blood pressure, high cholesterol.

What is claimed is:

1. A composite of natural foods for enhancing the normalization of tear secretion comprising eels, soybeans, oats, corn, champignons and sesames.

2. The composite as claimed in claim 1, wherein the composite is used in the treatment of dry eye.

3. The composite as claimed in claim 1, wherein the composite includes approximately 50-70% by weight of eels, approximately 5-10% by weight of soybeans, approximately 5-10% by weight of oats, approximately 5-10% by weight of corn, approximately 5-10% by weight of champignons and approximately 5-10% by weight of sesames.

4. The composite as claimed in claim 1, wherein the soybeans further contain sterols, the sesames further contain steroidal saponins, the oats further contain β-sitosterols, the champignons further contain ergosterols and the foregoing steroid compounds, they contain plant steroid hormones which have the efficacy of nourishing, anti-inflammation and maintaining homeostasis.

5. The composite as claimed in claim 1, wherein the composite comprising 50% by weight of eels, 10% by weight of soybeans, 10% by weight of oats, 10% by weight of corn, 10% by weight of champignons and 10% by weight of sesames is preferred.

6. The composite as claimed in claim 2, wherein the composite includes approximately 50-70% by weight of eels, approximately 5-10% by weight of soybeans, approximately 5-10% by weight of oats, approximately 5-10% by weight of corn, approximately 5-10% by weight of champignons and approximately 5-10% by weight of sesames.

7. The composite as claimed in claim 2, wherein the soybeans further contain sterols, the sesames further contain steroidal saponins, the oats further contain β-sitosterols, the champignons further contain ergosterols and the foregoing steroid compounds, they contain plant steroid hormones which have the efficacy of nourishing, anti-inflammation and maintaining homeostasis.

8. The composite as claimed in claim 2, wherein the composite comprising 50% by weight of eels, 10% by weight of soybeans, 10% by weight of oats, 10% by weight of corn, 10% by weight of champignons and 10% by weight of sesames is preferred.
